(19) United States
(12) Patent Application Publication
(10) Pub. No.: US 2012/0100801 A1
(43) Pub. Date: Apr. 26, 2012

(54) WIRELESS BASE STATION AND METHOD FOR RECEIVING SIGNAL OF WIRELESS BASE STATION

(75) Inventors: Yi Yuan, Shanghai (CN); Ganghua Yang, Shanghai (CN); Maosheng Huang, Shenzhen (CN)

(73) Assignee: Huawei Technologies Co., Ltd., Shenzhen (CN)

(21) Appl. No.: 13/339,889

(22) Filed: Dec. 29, 2011

Related U.S. Application Data
(63) Continuation of application No. PCT/CN2011/073866, filed on May 10, 2011.

(30) Foreign Application Priority Data
May 31, 2010 (CN) 201010188622.3

(51) Int. Cl. H04W 88/04

(52) U.S. Cl. 455/14

(57) ABSTRACT

Embodiments of the present disclosure disclose a wireless base station and a method for receiving a signal of the wireless base station. The wireless base station includes a base station indoor apparatus and a base station outdoor apparatus. The base station outdoor apparatus includes an adapter, a terrestrial service antenna, and a satellite antenna. The terrestrial service antenna is a microwave transmission antenna or a wireless access antenna. The base station indoor apparatus includes a satellite signal processing module configured to obtain a satellite service signal by decoding on a satellite radio-frequency signal received by the satellite antenna. The satellite antenna and the terrestrial service antenna are connected to the adapter. The adapter is configured to couple a signal received by the satellite antenna and a signal received by the terrestrial service antenna, and transfers a coupled signal to the base station indoor apparatus through a first data line.

### CROSS-REFERENCE TO RELATED APPLICATIONS

This application is a continuation of International Application No. PCT/CN2011/073866, filed on May 10, 2011, which claims priority to Chinese Patent Application No. 201010188622.3, filed on May 31, 2010, both of which are hereby incorporated by reference in their entireties.

### FIELD OF THE INVENTION

The present disclosure relates to the field of communication technologies, and in particular, to a wireless base station and a method for receiving a signal of the wireless base station.

### BACKGROUND OF THE INVENTION

In order to meet the requirements of clock precision, currently, a satellite receiving system is installed in some wireless base stations, so as to use the clock signals provided by a satellite to control the clock of the base station.

Referring to FIG. 1, an existing wireless base station generally includes two parts, that is, a base station indoor apparatus and a base station outdoor apparatus. The base station outdoor apparatus mainly includes a satellite antenna for receiving a satellite radio-frequency signal and a wireless access antenna for transmitting and receiving access side radio-frequency signals for interacting with a terminal. The base station indoor apparatus mainly includes a baseband unit (mainly responsible for functions such as baseband service signal processing, main control, clock and transmission, abbreviated as BBU) and a radio-frequency unit (mainly responsible for radio-frequency processing of transmitted and received signals, abbreviated as RRU). A satellite receiver card is set in the BBU or placed indoor independently, and is mainly configured to perform decoding processing on the satellite radio-frequency signal received by the satellite antenna to obtain clock signals and provide the clock signals used for clock control for the BBU.

In a wireless base station of an existing architecture, a feeder (with a length up to several meters) needs to be laid between the base station outdoor apparatus and the base station indoor apparatus for the satellite receiving system individually, so as to transmit the satellite signal received by the satellite antenna to the satellite receiver card for demodulation processing. The wiring is relatively complex, and the manufacturing cost is relatively high.

### SUMMARY OF THE INVENTION

Embodiments of the present disclosure provide a wireless base station and a method for receiving a signal of the wireless base station, so as to solve problems of complex wiring and relatively high manufacturing cost in the prior art.

In order to solve the foregoing technical problems, the embodiments of the present disclosure provide the following technical solutions:

A wireless base station includes:

a base station indoor apparatus and a base station outdoor apparatus,

where, the base station outdoor apparatus includes an adapter, a terrestrial service antenna, and a satellite antenna, and the terrestrial service antenna is a microwave transmission antenna or a wireless access antenna;

the base station indoor apparatus includes a satellite signal processing module, configured to obtain a satellite service signal by performing decoding processing on a satellite radio-frequency signal received by the satellite antenna; and

the satellite antenna and the terrestrial service antenna are connected to the adapter, and the adapter is configured to couple a signal received by the satellite antenna and a signal received by the terrestrial service antenna, and transfer a coupled signal to the base station indoor apparatus through a first data line.

A wireless base station includes:

a base station indoor apparatus and a base station outdoor apparatus,

where, the base station outdoor apparatus includes a terrestrial service antenna, a satellite antenna, a satellite signal processing module configured to obtain a satellite service signal by performing decoding processing on a satellite radio-frequency signal received by the satellite antenna, and a first terrestrial service processing module configured to demodulate and process a modulated signal received by the terrestrial service antenna; and the terrestrial service antenna is a microwave transmission antenna or a wireless access antenna; and

the satellite service signal is transferred to the base station indoor apparatus through a second data line, and the modulated signal, which is received by the terrestrial service antenna and demodulated by the first terrestrial service processing module, is transferred to the base station indoor apparatus through the second data line.

A method for receiving a signal of a wireless base station includes:

coupling, by an adapter located in a base station outdoor apparatus, a signal received by a satellite antenna and a signal received by a terrestrial service antenna, where the terrestrial service antenna includes a microwave transmission antenna or a wireless access antenna, and the microwave transmission antenna or the wire less access antenna is located in the base station outdoor apparatus;

transferring, by the adapter, a coupled signal to a base station indoor apparatus through a first data line; and

obtaining, by a satellite signal processing module located in the base station indoor apparatus, a satellite service signal by performing decoding processing on a satellite radio-frequency signal received by the satellite antenna.

A method for receiving a signal of a wireless base station includes:

obtaining, by a satellite signal processing module located in a base station outdoor apparatus, a satellite service signal by decoding a satellite radio-frequency signal received by a satellite antenna located in the base station outdoor apparatus;

transferring the satellite service signal to a base station indoor apparatus through a second data line; and

performing, by a first terrestrial service processing module located in the base station outdoor apparatus, demodulation processing on a modulated signal received by a terrestrial service antenna located in the base station outdoor apparatus, and transferring the signal after the demodulation processing to the base station indoor apparatus through the second data line.

It can be seen from the foregoing that, in a solution according to an embodiment of the present disclosure, the satellite signal processing module is set in the base station indoor apparatus, and signals of the satellite antenna and at least one of other antennas are transferred from the base station outdoor apparatus to the base station indoor apparatus through one data line, so that feeder wiring between the base station outdoor apparatus and the base station indoor apparatus is simplified, and meanwhile, because the two paths of signals are combined, the data lines after combination may use one lightning protection module. In comparison with the solution in which two paths of signals respectively use one lightning protection module, the number of the lightning protection modules may be reduced, and the manufacturing cost is lowered.

In another solution according to an embodiment of the present disclosure, the satellite signal processing module is set in the base station outdoor apparatus, and signals of the satellite antenna and at least one of other antennas after processing are transferred from the base station outdoor apparatus to the base station indoor apparatus through one data line, so that feeder wiring between the base station outdoor apparatus and the base station indoor apparatus is simplified, and meanwhile, because the two paths of signals are combined, the data lines after combination may use one lightning protection module. In comparison with the solution in which two paths of signals respectively use one lightning protection module, the number of the lightning protection modules may be reduced, and the manufacturing cost is lowered.

### BRIEF DESCRIPTION OF THE DRAWINGS

In order to illustrate the technical solutions according to the embodiments of the present disclosure and in the prior art more clearly, accompanying drawings needed for describing the embodiments and the prior art are given briefly below. Apparently, the accompanying drawings in the following description are only some embodiments of the present disclosure, and persons of ordinary skill in the art may further obtain other drawings from the accompanying drawings without creative efforts.

FIG. 1 is a schematic diagram of a wireless base station in the prior art;

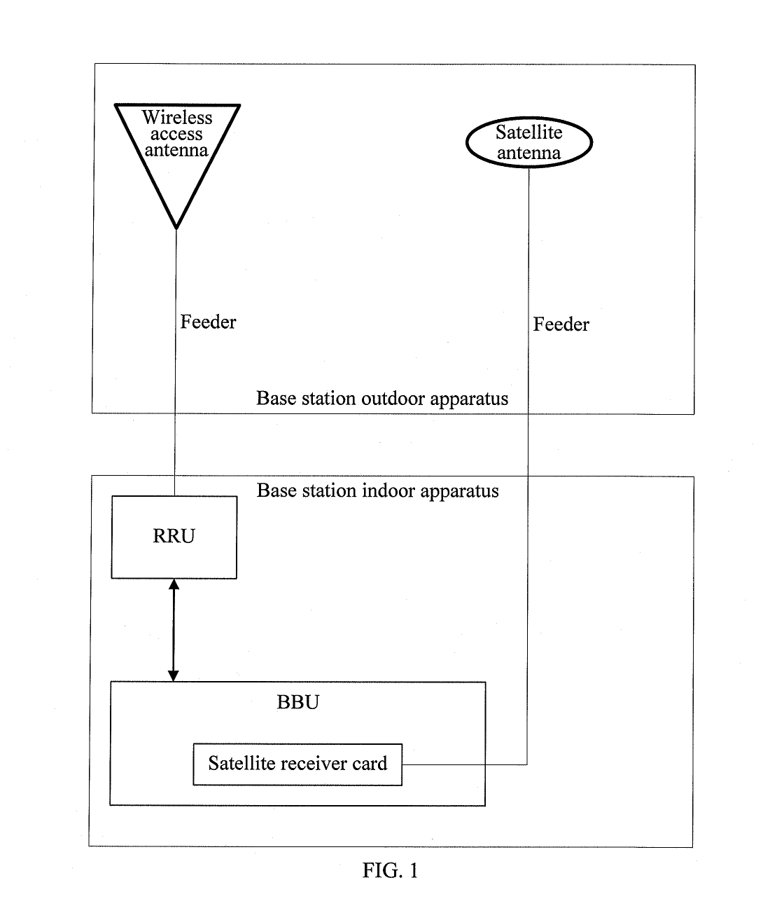

FIG. 2 is a schematic diagram of a wireless base station according to a first embodiment of the present disclosure;

FIG. 3-a is a schematic diagram of a wireless base station according to a second embodiment of the present disclosure;

FIG. 3-b is a schematic diagram of a wireless base station signal flow according to the second embodiment of the present disclosure;

FIG. 4-a is a schematic diagram of a wireless base station according to a third embodiment of the present disclosure;

FIG. 4-b is a schematic diagram of a wireless base station signal flow according to the third embodiment of the present disclosure;

FIG. 5-a is a schematic diagram of a wireless base station according to a fourth embodiment of the present disclosure;

FIG. 5-b is a schematic diagram of another wireless base station according to the fourth embodiment of the present disclosure;

FIG. 5-c is a schematic diagram of another wireless base station according to the fourth embodiment of the present disclosure;

FIG. 6-a is a schematic diagram of a wireless base station according to a fifth embodiment of the present disclosure;

FIG. 6-b is a schematic diagram of another wireless base station according to the fifth embodiment of the present disclosure;

FIG. 6-c is a schematic diagram of a wireless base station signal flow according to the fifth embodiment of the present disclosure;

FIG. 7-a is a schematic diagram of a wireless base station according to a sixth embodiment of the present disclosure; and

FIG. 7-b is a schematic diagram of a wireless base station signal flow according to the sixth embodiment of the present disclosure.

### DETAILED DESCRIPTION OF THE EMBODIMENTS

Embodiments of the present disclosure provide a wireless base station, which can simplify feeder wiring of the wireless base station and decrease a manufacturing cost.

The embodiments are respectively described in detail in the following.

### Embodiment 1

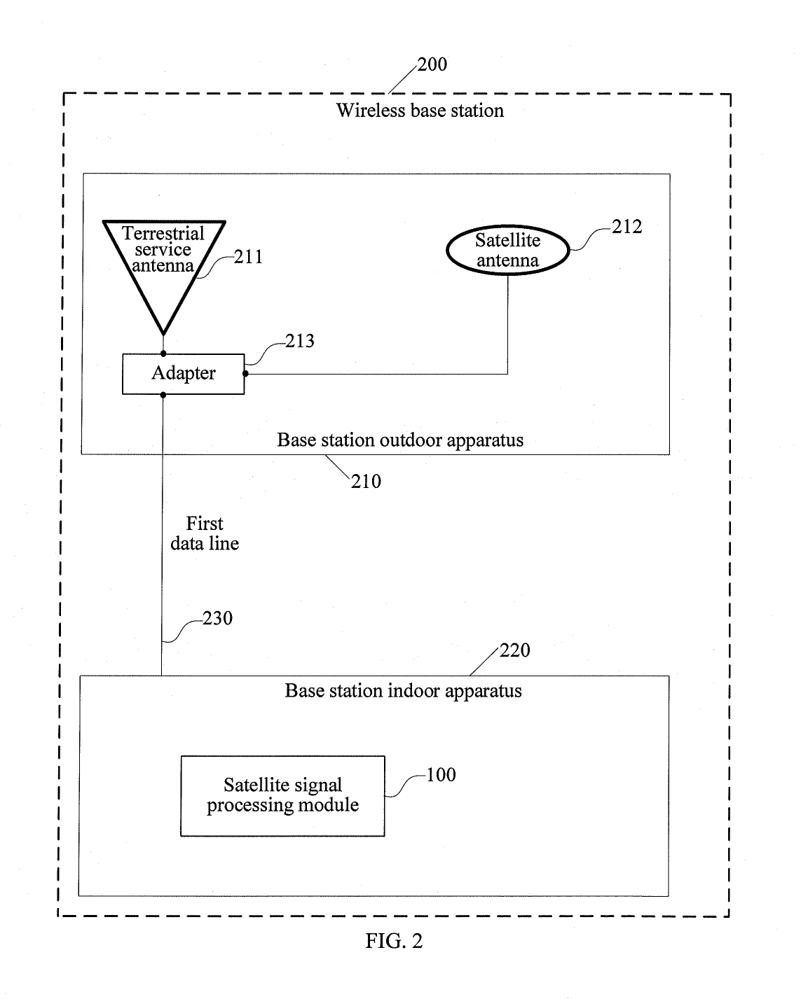

Referring to FIG. 2, an embodiment of the present disclosure provides a wireless base station, where the wireless base station 200 may include a base station outdoor apparatus 210 and a base station indoor apparatus 220.

The base station outdoor apparatus 210 may include a terrestrial service antenna 211, a satellite antenna 212, and an adapter 213.

The terrestrial service antenna 211 may be a microwave transmission antenna or a wireless access antenna.

The base station indoor apparatus 220 may include a satellite signal processing module 100, configured to obtain a satellite service signal by performing decoding processing on a satellite radio-frequency signal received by the satellite antenna 212.

The satellite radio-frequency signal received by the satellite antenna 212 is transferred to the base station indoor apparatus 220 through a first data line 230, and a modulated signal received by the terrestrial service antenna 211 is transferred to the base station indoor apparatus 220 through the first data line 230.

In an application scenario, the satellite antenna 212 and the terrestrial service antenna 211 may be connected to the adapter 213, and the adapter 213 is connected to the base station indoor apparatus 220 through the first data line 230. The adapter 213 may couple the satellite radio-frequency signal received by the satellite antenna 212 and the modulated signal received by the terrestrial service antenna 211 into one path of signal (the adapter may perform necessary impedance matching processing on the signals), and transfer a coupled signal to the base station indoor apparatus 220 through the first data line 230, so that the signals from two antennas are transferred from the base station outdoor apparatus 210 to the base station indoor apparatus 220 through one data line, and feeder wiring between the base station outdoor apparatus and the base station indoor apparatus may be simplified.

The first data line 230 may be a feeder or signal transfer line of another type.

After receiving the coupled signal, the base station indoor apparatus 220 decouples the signal, and processes the signal received by the satellite antenna and the signal received by the terrestrial service antenna through a corresponding processing circuit, for example, processes the signal received by the satellite antenna through a satellite signal processing module and processes the signal received by the terrestrial service antenna through a microwave or wireless processing circuit.

It can be understood that, as the signals of two antennas are transferred from the base station outdoor apparatus 210 to the base station indoor apparatus 220 through one data line, the data line is connected to one lightning protection circuit (or referred to as a lightning protection module), so that lightning protection processing may be applied on the two antennas by sharing one lightning protection circuit, which reduces the number of the lightning protection circuits in comparison with the prior art.

In an application scenario, if the terrestrial service antenna 211 is a wireless access antenna, the satellite signal processing module 100 may be set in an RRU of the base station indoor apparatus 220.

A BBU and the RRU may be connected through a standard Common Public Radio Interface (CPRI) or an Open Base Station Architecture Initiative (OBSAI) interface, and the physical carrier of the interface is an optical fiber or a conducting wire.

Besides the wired transmission with the optical fiber, the data transmission between network side devices such as the wireless base station according to the embodiment of the present disclosure and a base station controller may also adopt wireless transmission with microwaves.

A microwave transmission device may include a microwave outdoor unit (abbreviated as ODU, mainly configured to perform frequency conversion processing on transmitted and received signals, including transducing a microwave radio-frequency signal received by the microwave transmission antenna into a microwave intermediate frequency signal; and transducing a microwave intermediate frequency signal to be transmitted into a microwave radio-frequency signal) and a microwave indoor unit (abbreviated as IDU, mainly configured to perform baseband processing on the transmitted and received signals, including performing baseband processing on a received microwave intermediate frequency signal to obtain a microwave service signal; and performing baseband processing on a microwave service signal to be transmitted to obtain a microwave intermediate frequency signal), or a microwave outdoor integrated device (that is, the microwave transmission device is entirely disposed in the base station outdoor apparatus).

In an application scenario, if the terrestrial service antenna 211 is a microwave transmission antenna, the satellite signal processing module 100 may be set in the IDU of the base station indoor apparatus 220.

It should be noted that, the satellite signal processing module 100 according to the embodiment of the present disclosure may be, for example, a satellite receiver card or another apparatus having similar functions.

In an application scenario, the satellite service signal, obtained through decoding the satellite radio-frequency signal by the satellite signal processing module 100, includes a clock signal and/or a position signal. In the embodiment of the present disclosure, the situation that the satellite service signal is a clock signal is specifically illustrated.

If a clock signal is obtained through decoding processing by the satellite signal processing module 100, the clock signal may be provided for the BBU of the base station indoor apparatus 220, so that the BBU may utilize the clock signal to perform clock calibration and control.

In this embodiment of the present disclosure, the satellite antenna may receive satellite radio-frequency signals from satellites such as the Galileo satellite, the Global Positioning System (GPS) satellite, the BeiDou satellite, and the Global Navigation Satellite System (GLONASS) satellite.

It can be seen from the foregoing that, in this embodiment, the satellite signal processing module is set in the base station indoor apparatus, and the signals of the satellite antenna and at least one of other antennas are transferred from the base station outdoor apparatus to the base station indoor apparatus through one data line, so that feeder wiring between the base station outdoor apparatus and the base station indoor apparatus is simplified, and meanwhile, the number of the lightning protection modules may also be reduced, and a manufacturing cost is lowered.

### Embodiment 2

In this embodiment, the situation that a satellite signal processing module is set in an IDU of a base station indoor apparatus is described as an example.

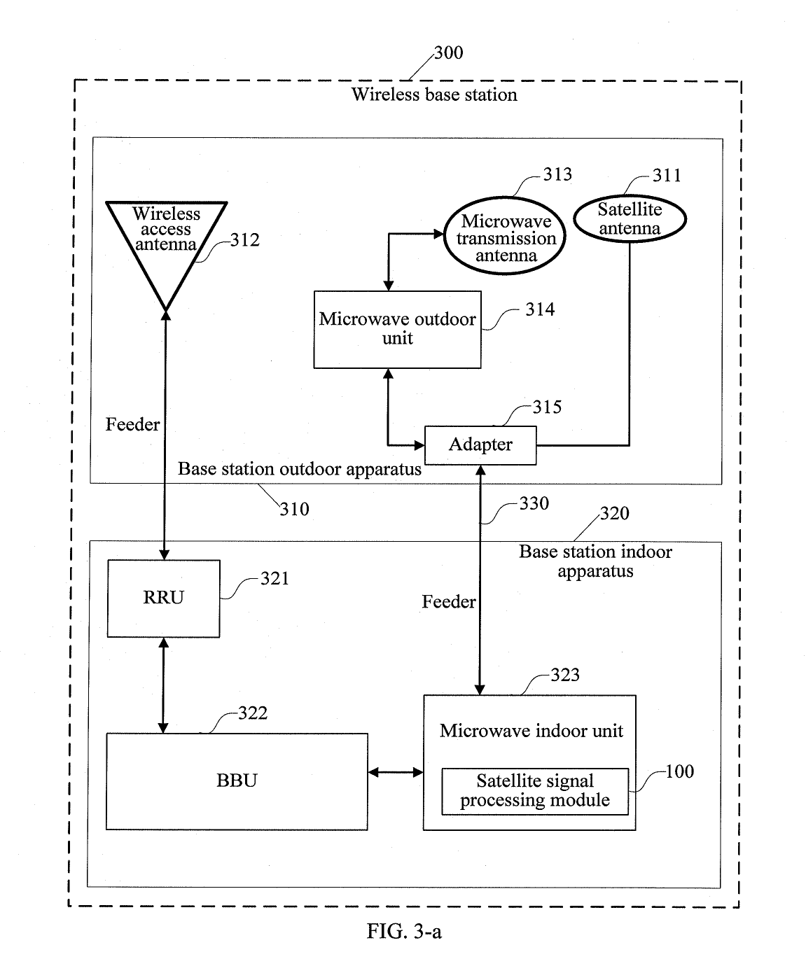

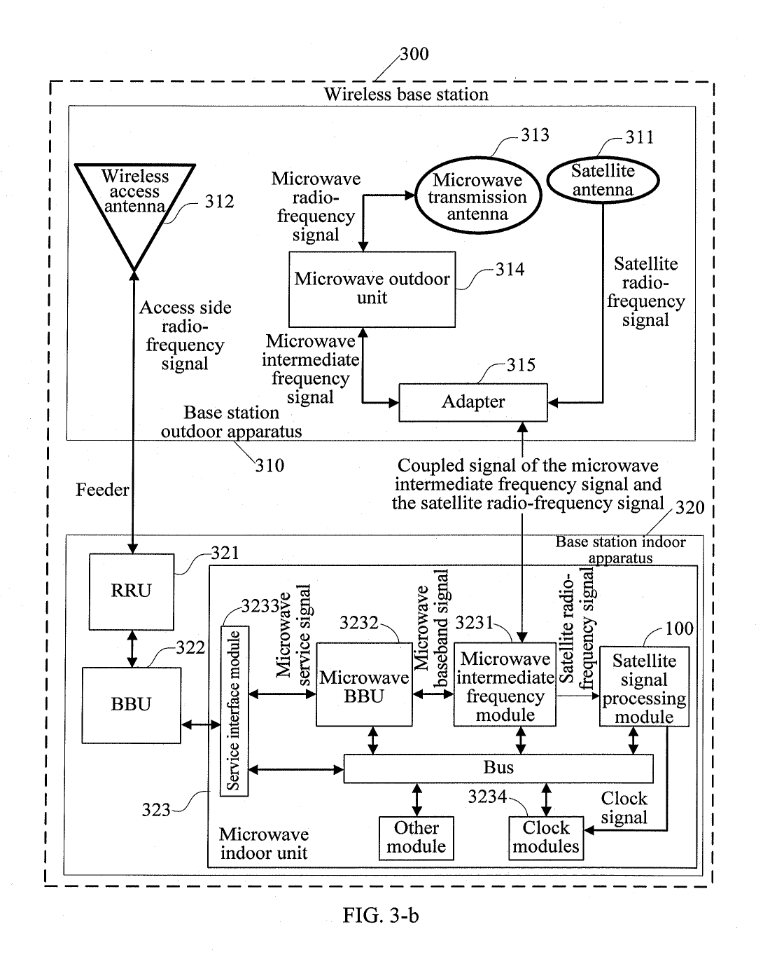

Referring to FIG. 3-a, an embodiment of the present disclosure provides a wireless base station, where the wireless base station 300 may include a base station outdoor apparatus 310 and a base station indoor apparatus 320.

The base station outdoor apparatus 310 may include a satellite antenna 311, a wireless access antenna 312, a microwave transmission antenna 313, an ODU 314, and an adapter 315 (the adapter 315 may also be set in the ODU 314). The base station indoor apparatus 320 may include an RRU 321, a BBU 322, an IDU 323, and a satellite signal processing module 100. The satellite signal processing module 100 may be set in the IDU 323.

The wireless access antenna 312 is connected to the RRU 321 through a feeder, and the RRU 321 and the BBU 322 are connected through a CPRI or an OBSAI interface. The RRU 321 performs radio-frequency processing on an access side radio-frequency signal received by the wireless access antenna 312 to obtain an access side baseband signal, and outputs the access side baseband signal to the BBU 322 for baseband processing. The BBU 322 may also output an access side baseband signal to be transmitted to the RRU 321, and the RRU 321 performs radio-frequency processing on the access side baseband signal to be transmitted to obtain an access side radio-frequency signal, and transmits the access side radio-frequency signal through the wireless access antenna 312.

The satellite antenna 311 is connected to the adapter 315. The microwave transmission antenna 313 is connected to the adapter 315 through the ODU 314, and the ODU 314 performs frequency conversion processing on a microwave radio-frequency signal received by the microwave transmission antenna 313 to obtain a microwave intermediate frequency signal, and outputs the microwave intermediate frequency signal to the adapter 315. The adapter 315 is connected to the IDU 323 in the base station indoor apparatus 320 through a feeder 330. The adapter 315 couples the satellite radio-frequency signal and the microwave intermediate frequency signal from the ODU 314 to obtain a coupled signal (the adapter may perform necessary impedance matching processing on the signals), and transfers the coupled signal to the IDU 323 through the feeder 330.

Parameters of the microwave intermediate frequency signal and the satellite radio-frequency signal are exemplified as follows:

| | |
|---|---|
| Microwave intermediate frequency signal Transmission | 350 |
| frequency (MHz) | |
| Receiving frequency (MHz) | 140 |
| Impedance (ohm) | 50 |
| Satellite radio-frequency signal Receiving frequency (GHz) | 1.5/2.4 |
| Impedance (ohm) | 50 |

The IDU 323 decouples the coupled signal into a satellite radio-frequency signal and a microwave intermediate frequency signal, and performs demodulation and baseband processing on the decoupled microwave intermediate frequency signal to obtain a microwave service signal; and outputs the decoupled satellite radio-frequency signal to the satellite signal processing module 100. The satellite signal processing module 100 obtains a satellite service signal (which may include a clock signal) by decoding the received satellite radio-frequency signal. The IDU 323 performs corresponding signal format conversion (for example, Ethernet format, Plesiochronous Digital Hierarchy (PDH) format, or Synchronous Digital Hierarchy (SDH) format) on the satellite service signal and the microwave service signal, and outputs the service signal after format conversion to the BBU 322 for processing.

If a clock signal is obtained through decoding the satellite radio-frequency signal by the satellite signal processing module 100, the IDU 323 may utilize the clock signal to calibrate the clock of the microwave service signal, and the BBU 322 may extract a clock signal from the microwave service signal after clock calibration (it can be understood that, because the IDU 323 utilizes the clock signal obtained through decoding the satellite radio-frequency signal by the satellite signal processing module 100 to perform clock calibration on the microwave service signal, the clock signal extracted by the BBU 322 from the microwave service signal after the clock calibration may be equivalent to the clock signal obtained through decoding the satellite radio-frequency signal by the satellite signal processing module 100), and utilize the clock signal to perform clock calibration and control.

Referring to FIG. 3-b, in an application scenario, the IDU 323 may include a microwave intermediate frequency module 3231, a microwave BBU 3232, a service interface module 3233, and a clock module 3234.

For example, the satellite radio-frequency signal carries a clock signal, and a signal flow direction in the base station 300 and a work mode of each module may be:

The satellite antenna 311 receives a satellite radio-frequency signal and outputs the satellite radio-frequency signal to the adapter 315 through a feeder. The microwave transmission antenna 313 receives a microwave radio-frequency signal and outputs the microwave radio-frequency signal to the ODU 314 through a feeder, and the ODU 314 performs frequency conversion processing on the microwave radio-frequency signal to obtain a microwave intermediate frequency signal, and outputs the microwave intermediate frequency signal to the adapter 315. The adapter 315 couples the satellite radio-frequency signal and the microwave intermediate frequency signal, and outputs a coupled signal of the satellite radio-frequency signal and the microwave intermediate frequency signal to the IDU 323 of the base station indoor apparatus 320. The microwave intermediate frequency module 3231 of the IDU 323 receives the coupled signal of the satellite radio-frequency signal and the microwave intermediate frequency signal, then decouples the coupled signal into a satellite radio-frequency signal and a microwave intermediate frequency signal, and outputs the decoupled satellite radio-frequency signal to the satellite signal processing module 100. The satellite signal processing module 100 decodes the received satellite radio-frequency signal to obtain a clock signal, and provides the clock signal for the clock module 3234. The clock module 3234 utilizes the clock signal to calibrate the clock, and performs clock control on the other modules of the IDU 323. The microwave intermediate frequency module 3231 further converts the decoupled microwave intermediate frequency signal into a microwave baseband signal, and outputs the microwave baseband signal to the microwave BBU 3232. Under the clock control of the clock module 3234, the microwave BBU 3232 performs baseband service processing on the microwave baseband signal to obtain a corresponding microwave service signal. The service interface module 3233 performs corresponding format conversion on the microwave service signal obtained by the microwave BBU 3232, and outputs the microwave service signal after the format conversion to the BBU 322. It can be understood that, because the clock module 3234 utilizes the clock signal obtained through decoding the received satellite radio-frequency signal by the satellite signal processing module 100 to calibrate the clock, and the microwave intermediate frequency module 3231, the microwave BBU 3232, and the service interface module 3233 all process the microwave signal under the clock control of the clock module 3234, the clock of the microwave service signal received by the BBU 322 is synchronized with that of the satellite. The BBU 322 may extract a clock signal (equivalent to the clock signal obtained through decoding the satellite radio-frequency signal by the satellite signal processing module 100) from the microwave service signal from the IDU 323, and utilize the clock signal to perform clock calibration and control.

It can be seen from the foregoing that, in this embodiment, the satellite signal processing module is set in the IDU of the base station indoor apparatus, and the signals of the satellite antenna and the microwave transmission antenna are transferred from the base station outdoor apparatus to the base station indoor apparatus through one data line, so that feeder wiring between the base station outdoor apparatus and the base station indoor apparatus is simplified, and meanwhile, the number of the lightning protection modules may also be reduced, and a manufacturing cost is lowered.

### Embodiment 3

In this embodiment, the situation that a satellite signal processing module is set in an RRU of a base station indoor apparatus is described as an example.

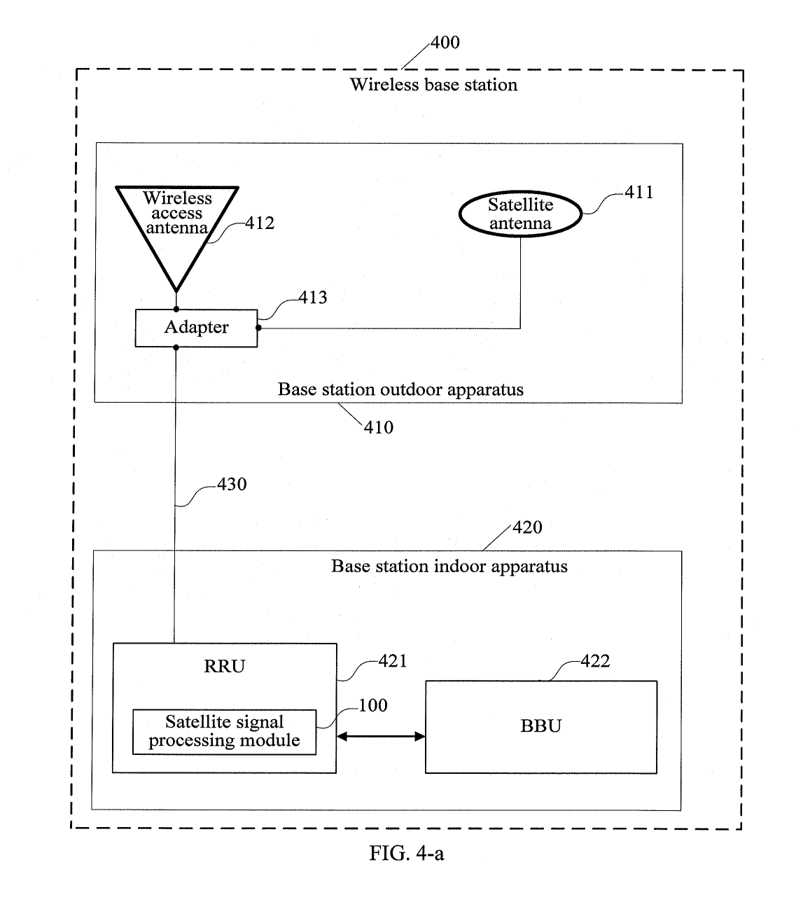

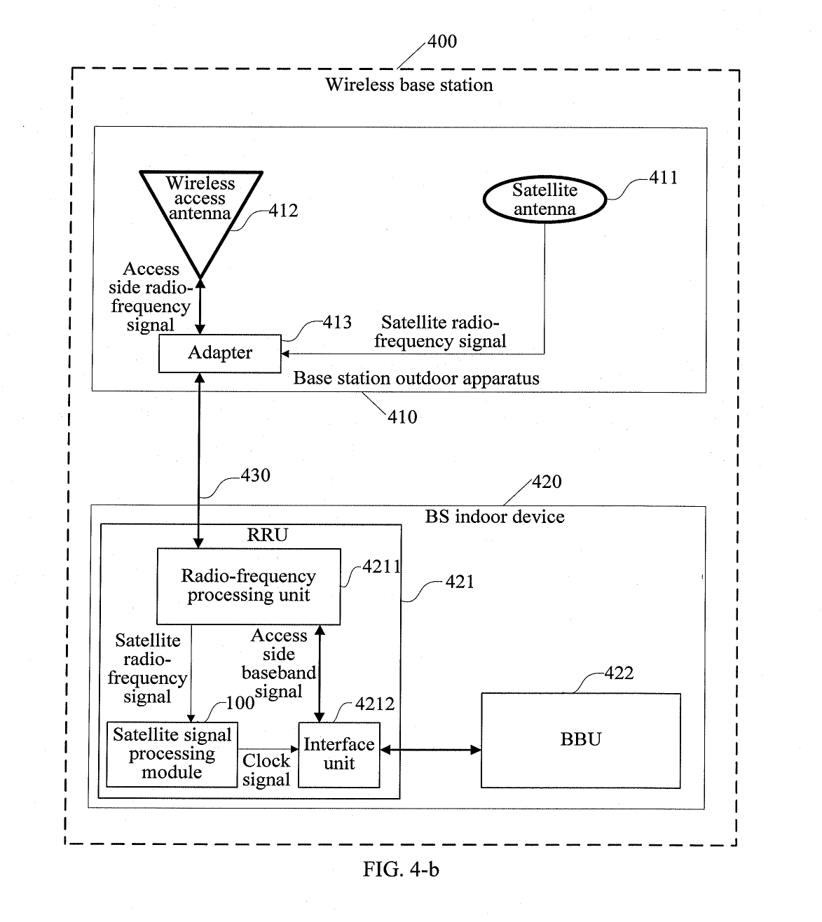

Referring to FIG. 4-a, another embodiment of the present disclosure provides a wireless base station, where the wireless base station 400 may include a base station outdoor apparatus 410 and a base station indoor apparatus 420.

The base station outdoor apparatus 410 may include a satellite antenna 411 for receiving a satellite radio-frequency signal, a wireless access antenna 412 for receiving an access side radio-frequency signal, and an adapter 413.

The base station indoor apparatus 420 may include an RRU 421, a BBU 422, and a satellite signal processing module 100. The satellite signal processing module 100 is set in the RRU 421.

The satellite antenna 411 and the wireless access antenna 412 are connected to the adapter 413, and the adapter 413 is connected to the RRU 421 of the base station indoor apparatus 420 through a feeder 430. The adapter 413 couples the satellite radio-frequency signal and the access side radio-frequency signal to obtain a coupled signal (the adapter may perform necessary impedance matching processing on the signals), and transfers the coupled signal to the RRU 421 through the feeder 430.

Parameters of the access side radio-frequency signal and the satellite radio-frequency signal are exemplified as follows:

| | |
|---|---|
| Access side radio-frequency signal Transmission | 0.7/0.9/1.8/2.1/ . . . |
| frequency (DHz) Receiving frequency (MHz) | |
| Impedance (ohm) | 50 |
| Satellite radio-frequency signal Receiving | 1.5/2.4 |
| frequency (GHz) | |
| Impedance (ohm) | 50 |

The RRU 421 receives the coupled signal of the satellite radio-frequency signal and the access side radio-frequency signal, decouples the coupled signal into a satellite radio-frequency signal and an access side radio-frequency signal, and performs radio-frequency processing on the decoupled access side radio-frequency signal to obtain an access side baseband signal; and outputs the decoupled satellite radio-frequency signal to the satellite signal processing module 100. The satellite signal processing module 100 obtains a satellite service signal (which may include a clock signal) by decoding the received satellite radio-frequency signal. The RRU 421 embeds the satellite service signal into the access side baseband signal, performs interface format conversion (for example, CPRI or OBSAI interface format), and outputs the access side baseband signal after interface format conversion to the BBU 422. The BBU 422 extracts the satellite service signal embedded in the access side baseband signal, and performs baseband processing on the access side baseband signal.

If a clock signal is obtained through decoding the satellite radio-frequency signal by the satellite signal processing module 100, the BBU 422 may extract the clock signal (equivalent to the clock signal obtained through decoding the satellite radio-frequency signal by the satellite signal processing module 100) embedded in the access side baseband signal, and utilize the clock signal to perform clock calibration and control.

Referring to FIG. 4-b, in an application scenario, the RRU 421 may include a radio-frequency processing unit 4211 and an interface unit 4212.

For example, the satellite radio-frequency signal carries a clock signal, and a signal flow direction in the base station 400 and a work mode of each module may be:

The satellite antenna 411 receives a satellite radio-frequency signal and outputs the satellite radio-frequency signal to the adapter 413 through a feeder; and the wireless access antenna 412 receives an access side radio-frequency signal and outputs the access side radio-frequency signal to the adapter 413. The adapter 413 couples the satellite radio-frequency signal and the access side radio-frequency signal, and outputs a coupled signal of the satellite radio-frequency signal and the access side radio-frequency signal to the RRU 421 of the base station indoor apparatus 420. The radio-frequency processing unit 4211 of the RRU 421 receives the coupled signal of the satellite radio-frequency signal and the access side radio-frequency signal, decouples the coupled signal into a satellite radio-frequency signal and an access side radio-frequency signal, performs frequency conversion on the decoupled access side radio-frequency signal into an access side baseband signal, and outputs the access side baseband signal to the interface unit 4212; and outputs the decoupled satellite radio-frequency signal to the satellite signal processing module 100. The satellite signal processing module 100 decodes the received satellite radio-frequency signal to obtain a clock signal, and outputs the clock signal to the interface unit 4212. The interface unit 4212 embeds the clock signal into the access side baseband signal, and outputs the access side baseband signal embedded with the clock signal to the BBU 422. The BBU 422 extracts the clock signal embedded in the access side baseband signal (because the interface unit 4212 embeds the clock signal obtained through decoding the received satellite radio-frequency signal by the satellite signal processing module 100 into the access side baseband signal, the clock signal extracted by the BBU 422 from the access side baseband signal from the interface unit 4212 is equivalent to the clock signal obtained through decoding the satellite radio-frequency signal by the satellite signal processing module 100), utilizes the clock signal to perform clock calibration and control, and performs baseband processing on the access side baseband signal.

It can be seen from the foregoing that, in this embodiment, the satellite signal processing module is set in the RRU of the base station indoor apparatus, and the signal received by the satellite antenna and the signal received by the wireless access antenna are transferred from the base station outdoor apparatus to the base station indoor apparatus through one data line, so that feeder wiring between the base station outdoor apparatus and the base station indoor apparatus is simplified, and meanwhile, the number of the lightning protection modules may also be reduced, and a manufacturing cost is lowered.

### Embodiment 4

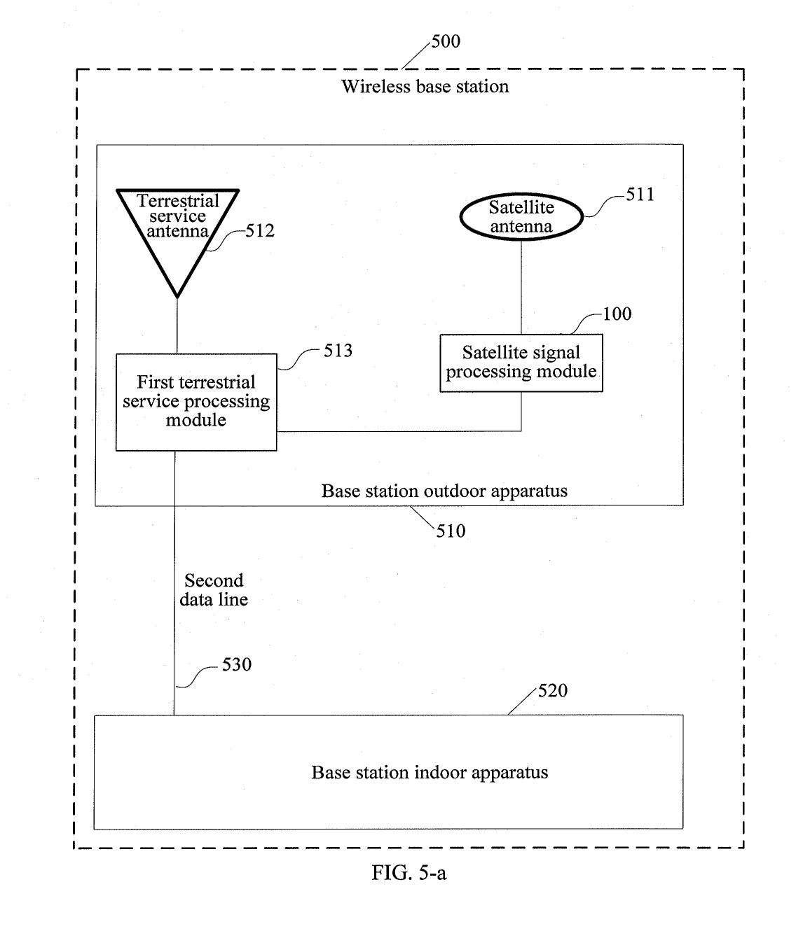

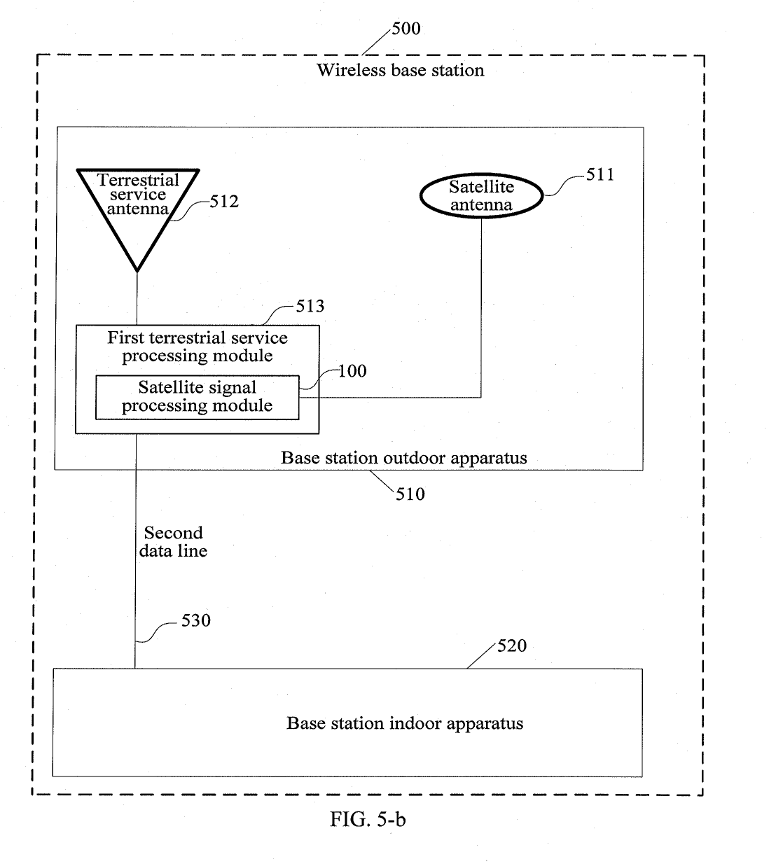

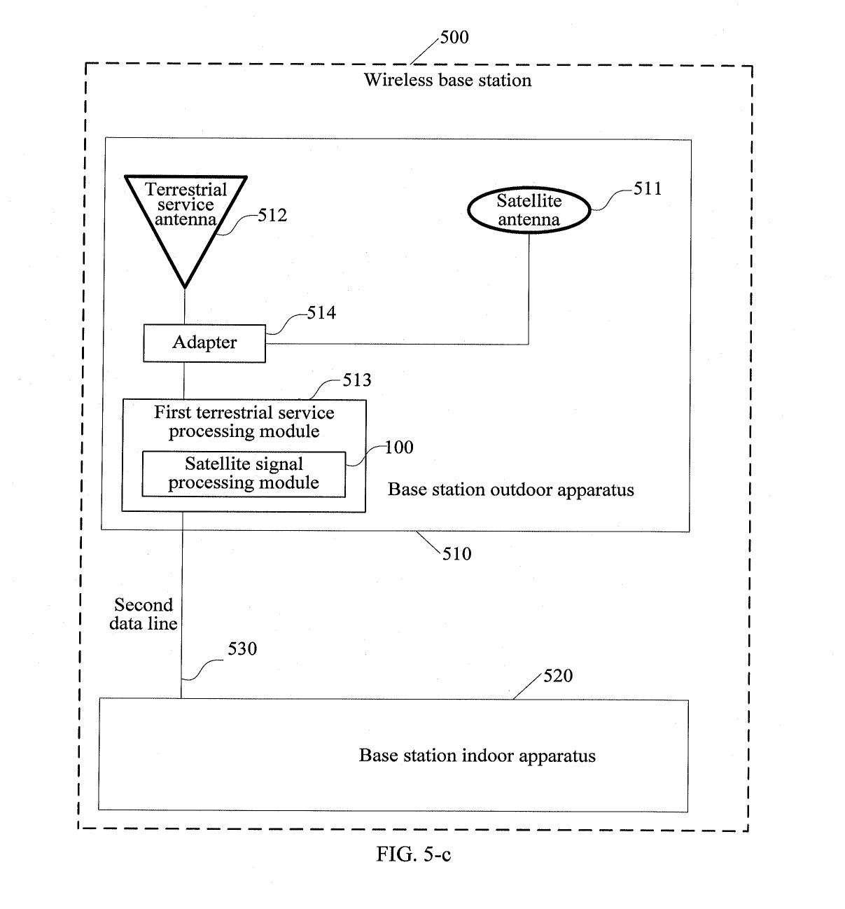

Referring to FIG. 5-a, another embodiment of the present disclosure provides a wireless base station, where the wireless base station 500 may include a base station outdoor apparatus 510 and a base station indoor apparatus 520.

The base station outdoor apparatus 510 includes a terrestrial service antenna 512, a satellite antenna 511, a satellite signal processing module 100 configured to obtain a satellite service signal by performing decoding processing on a satellite radio-frequency signal received by the satellite antenna, and a first terrestrial service processing module 513 configured to demodulate a modulated signal received by the terrestrial service antenna 512. The terrestrial service antenna 512 may be a microwave transmission antenna or a wireless access antenna.

The satellite service signal is transferred to the base station indoor apparatus 520 through a second data line 530, and the modulated signal, which is received by the terrestrial service antenna 512 and demodulated by the first terrestrial service processing module 513, is transferred to the base station indoor apparatus 520 through the second data line 530.

The second data line 530 may be an optical fiber, a cable, or a signal transfer line of another type.

In an application scenario, the satellite signal processing module 100 may obtain a satellite service signal by performing decoding processing on a satellite radio-frequency signal received by the satellite antenna, and outputs a satellite signal of the satellite service signal to the first terrestrial service processing module 513. The first terrestrial service processing module 513 may be further configured to embed the satellite service signal in the modulated signal received by the terrestrial service antenna 512 after demodulation processing to obtain a coupled signal, and transfer the coupled signal to the base station indoor apparatus 520 through the second data line 530.

Referring to FIG. 5-b, in an application scenario, the satellite signal processing module 100 may be set in the first terrestrial service processing module 513.

In an application scenario, if the terrestrial service antenna 512 is a wireless access antenna, the first terrestrial service processing module 513 may be an RRU, and the satellite signal processing module 100 may be set in the RRU.

In an application scenario, if the terrestrial service antenna 512 is a microwave transmission antenna, the first terrestrial service processing module 513 is a microwave outdoor integrated device, and the satellite signal processing module 100 may be set in the microwave outdoor integrated device.

Referring to FIG. 5-c, in an application scenario, the satellite antenna 511 may be connected to a lightning protection circuit (not shown in the figure) of the first terrestrial service processing module 513 through an adapter 514, and the adapter 514 couples the signal received by the satellite antenna 511 and the signal received by the terrestrial service antenna 512, and transfers the coupled signal to the first terrestrial service processing module 513. This method may realize the sharing of the lightning protection circuit, so that the number of the lightning protection circuits is reduced, in comparison with the prior art.

In an application scenario, the satellite service signal obtained through decoding the satellite radio-frequency signal by the satellite signal processing module 100 includes a clock signal and/or a position signal. In this embodiment of the present disclosure, the situation that the satellite service signal is a clock signal is specifically illustrated.

If a clock signal is obtained through decoding processing by the satellite signal processing module 100, the clock signal may be further provided for the BBU of the base station indoor apparatus 520, so that the BBU may utilize the clock signal to perform clock calibration and control.

It can be seen from the foregoing that, in this embodiment, the satellite signal processing module is set in the base station outdoor apparatus, and the signal received by the satellite antenna and the signal received by at least one of other antennas after processing are transferred from the base station outdoor apparatus to the base station indoor apparatus through one data line, so that feeder wiring between the base station outdoor apparatus and the base station indoor apparatus is simplified, and meanwhile, the number of the lightning protection modules may also be reduced, and a manufacturing cost is lowered.

### Embodiment 5

In this embodiment, the situation that a satellite signal processing module is set in an RRU of a base station outdoor apparatus is described as an example.

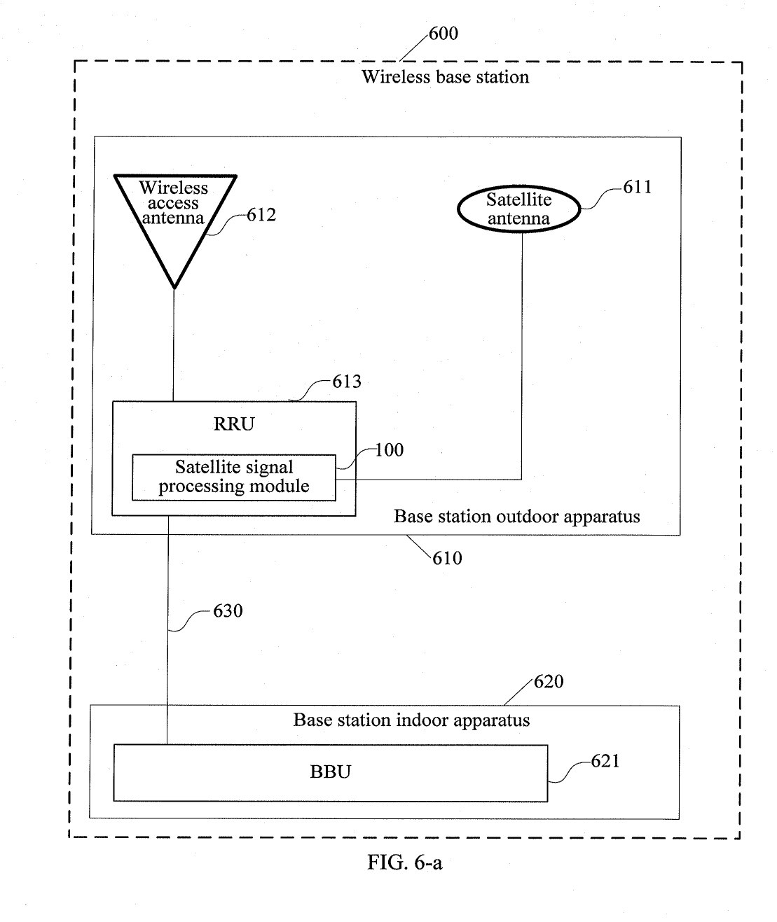

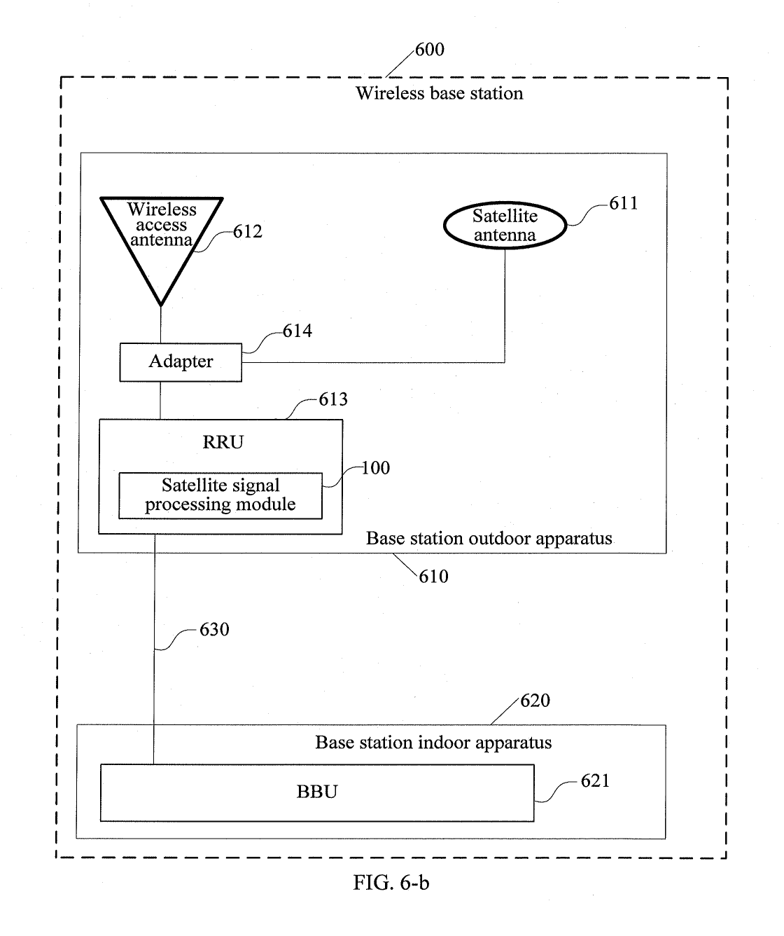

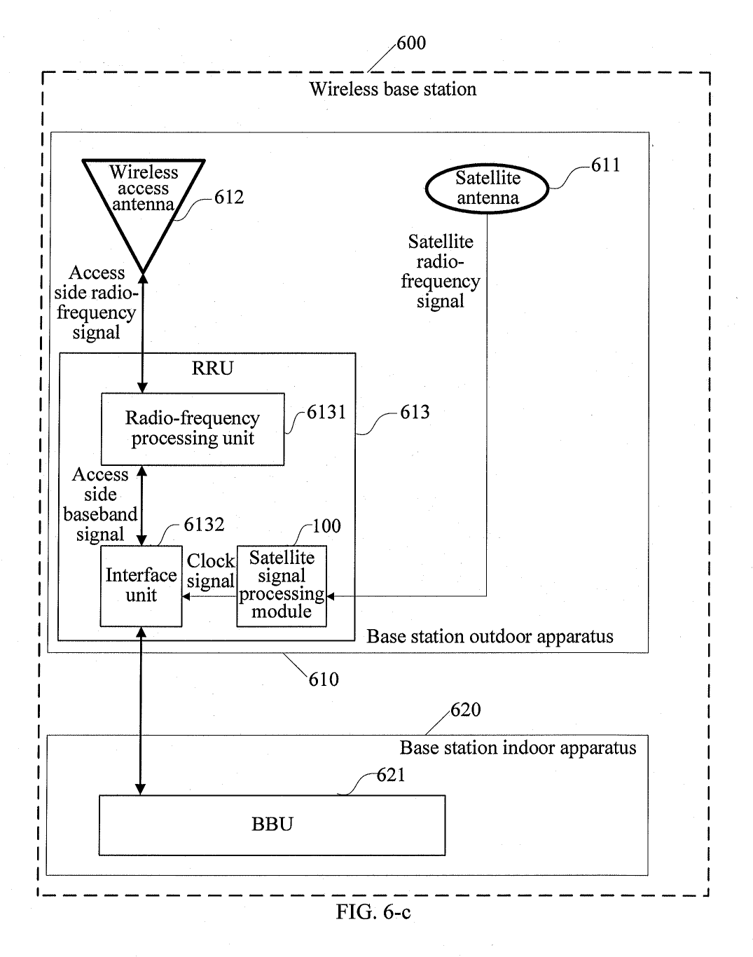

Referring to FIG. 6-a, another embodiment of the present disclosure provides a wireless base station, where the wireless base station 600 may include a base station outdoor apparatus 610 and a base station indoor apparatus 620.

The base station outdoor apparatus 610 may include a satellite antenna 611 for receiving a satellite radio-frequency signal, a wireless access antenna 612 for receiving an access side radio-frequency signal, an RRU 613, and a satellite signal processing module 100 configured to obtain a satellite service signal by performing decoding processing on the satellite radio-frequency signal received by the satellite antenna 611. The satellite signal processing module 100 may be set in the RRU 613, and certainly, may also be set outside the RRU 613.

The base station indoor apparatus 620 may include a BBU 621.

The satellite radio-frequency signal received by the satellite antenna 611 is transferred to the satellite signal processing module 100; and the access side radio-frequency signal received by the wireless access antenna 612 is transferred to the RRU 613.

The RRU 613 performs radio-frequency processing on the access side radio-frequency signal to obtain an access side baseband signal; and the satellite signal processing module 100 obtains a satellite service signal (which may include a clock signal) by decoding the received satellite radio-frequency signal. The RRU 613 may embed the satellite service signal into the access side baseband signal, perform interface format conversion (for example, CPRI or OBSAI interface format), and output the access side baseband signal after interface format conversion to the BBU 621. The BBU 621 extracts the satellite service signal embedded in the access side baseband signal, and performs baseband processing on the access side baseband signal.

If a clock signal is obtained through decoding the satellite radio-frequency signal by the satellite signal processing module 100, the BBU 621 may extract the clock signal embedded in the access side baseband signal (because the RRU 613 embeds the clock signal obtained through decoding the received satellite radio-frequency signal by the satellite signal processing module 100 into the access side baseband signal, the clock signal extracted by the BBU 621 from the access side baseband signal from the RRU 613 is equivalent to the clock signal obtained through decoding the satellite radio-frequency signal by the satellite signal processing module 100), and utilize the clock signal to perform clock calibration and control.

Referring to FIG. 6-b, in another application scenario, the base station outdoor apparatus 610 may further include an adapter 614, so that a signal received by the satellite antenna 611 and a signal received by the wireless access antenna 612 are coupled by the adapter 614, and a coupled signal is transferred to the RRU 613. For the specific processing procedure, reference may be made to the relevant description in the third embodiment.

Referring to FIG. 6-c, in an application scenario, the RRU 613 may include a radio-frequency processing unit 6131 and an interface unit 6132.

For example, the satellite radio-frequency signal carries a clock signal, and a signal flow in the base station 600 and a work mode of each module may be:

The satellite antenna 611 receives a satellite radio-frequency signal and outputs the satellite radio-frequency signal to the satellite signal processing module 100 through a feeder; and the wireless access antenna 612 receives the access side radio-frequency signal and outputs the access side radio-frequency signal to the RRU 613. The radio-frequency processing unit 6131 of the RRU 421 receives the access side radio-frequency signal, and performs frequency conversion on the access side radio-frequency signal into an access side baseband signal, and outputs the access side baseband signal to the interface unit 6132. The satellite signal processing module 100 decodes the received satellite radio-frequency signal to obtain a clock signal, and outputs the clock signal to the interface unit 6132. The interface unit 6132 embeds the clock signal into the access side baseband signal, and outputs the access side baseband signal embedded with the clock signal to the BBU 621 through a data line 630. The BBU 621 extracts the clock signal embedded in the access side baseband signal (because the interface unit 6132 of the RRU 613 embeds the clock signal obtained through decoding the received satellite radio-frequency signal by the satellite signal processing module 100 into the access side baseband signal, the clock signal extracted by the BBU 621 from the access side baseband signal from the interface unit 6132 is equivalent to the clock signal obtained through decoding the satellite radio-frequency signal by the satellite signal processing module 100), utilizes the clock signal to perform clock calibration and control, and performs baseband processing on the access side baseband signal.

It can be seen from the foregoing that, in this embodiment, the satellite signal processing module is set in the RRU of the base station indoor apparatus, and the signal received by the satellite antenna and the signal received by at least one of other antennas after processing are transferred from the base station outdoor apparatus to the base station indoor apparatus through one data line, so that feeder wiring between the base station outdoor apparatus and the base station indoor apparatus is simplified, and meanwhile, the number of the lightning protection modules may also be reduced, and a manufacturing cost is lowered.

### Embodiment 6

In this embodiment, the situation that a satellite signal processing module is set in a microwave outdoor integrated device of a base station outdoor apparatus is described as an example.

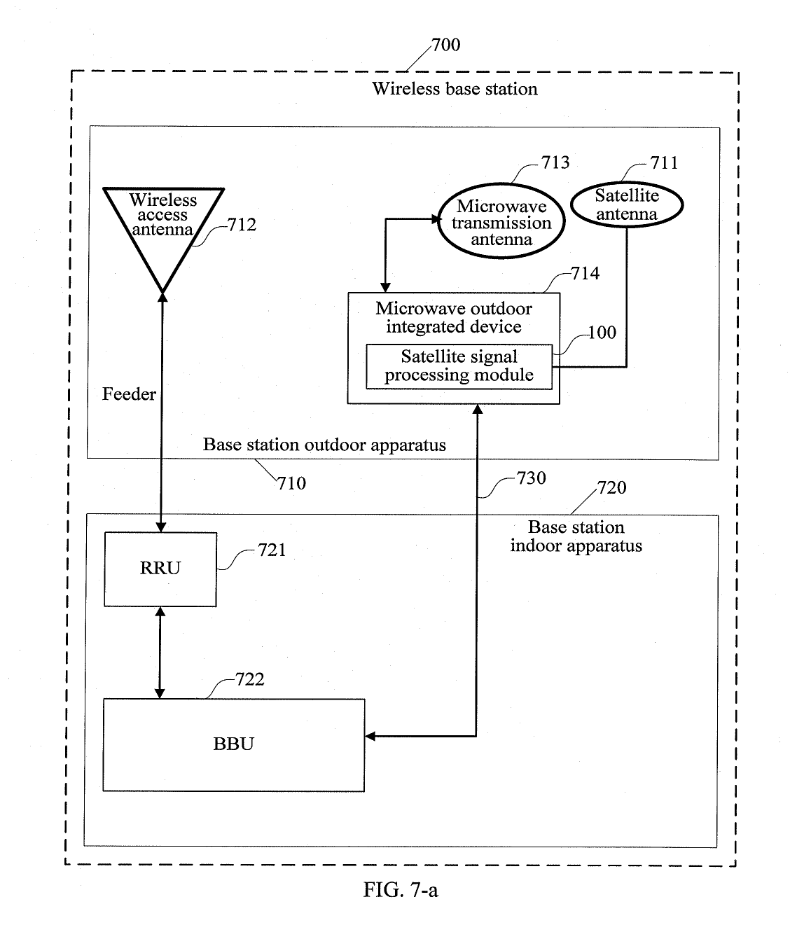

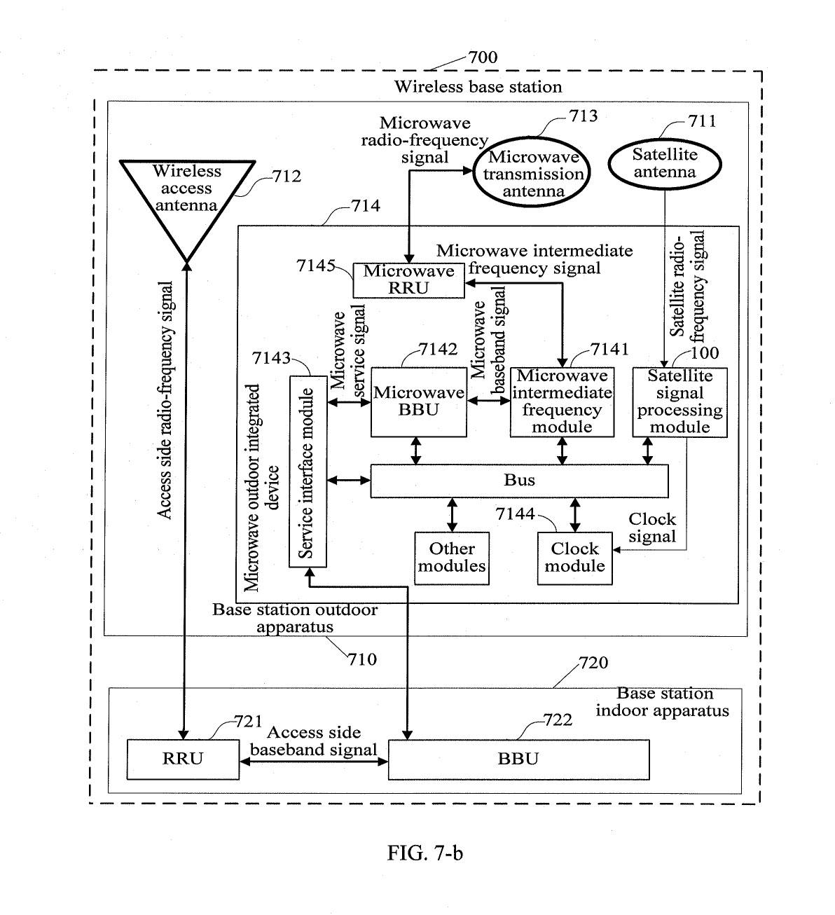

Referring to FIG. 7-a, another embodiment of the present disclosure provides a wireless base station, where the wireless base station 700 may include a base station outdoor apparatus 710 and a base station indoor apparatus 720.

The base station outdoor apparatus 710 may include a satellite antenna 711, a wireless access antenna 712, a microwave transmission antenna 713, a microwave outdoor integrated device 714, and a satellite signal processing module 100.

The base station indoor apparatus 720 may include an RRU 721 and a BBU 722.

The satellite signal processing module 100 is set in the microwave outdoor integrated device 714.

The wireless access antenna 712 is connected to the RRU 721 through a feeder, and the RRU 721 and the BBU 722 are connected through a CPRI or an OB SAI interface. The RRU 721 performs radio-frequency processing on an access side radio-frequency signal received by the wireless access antenna 712 to obtain an access side baseband signal, and outputs the access side baseband signal to the BBU 722 for baseband processing. The BBU 722 may also output an access side baseband signal to be transmitted to the RRU 721, and the RRU 721 performs radio-frequency processing on the access side baseband signal to be transmitted to obtain an access side radio-frequency signal, and transmits the access side radio-frequency signal through the wireless access antenna 712.

The satellite antenna 711 is connected to the satellite signal processing module 100, and the satellite signal processing module 100 obtains a satellite service signal (which may include a clock signal) by decoding a satellite radio-frequency signal received by the satellite antenna 711. The microwave transmission antenna 713 is connected to the microwave outdoor integrated device 714, and the microwave outdoor integrated device 714 decodes a microwave radio-frequency signal received by the microwave transmission antenna 713 to obtain a microwave service signal. The microwave outdoor integrated device 714 embeds the satellite service signal into the microwave service signal, performs signal format conversion (for example, Ethernet format, PDH format, or SDH format), and outputs the service signal after format conversion through a data line 730 to the BBU 722 for processing.

If a clock signal is obtained through decoding the satellite radio-frequency signal by the satellite signal processing module 100, the microwave outdoor integrated device 714 may utilize the clock signal to calibrate the clock of the microwave service signal, and the BBU 722 may extract a clock signal from the microwave service signal after the clock calibration (it can be understood that, because the microwave outdoor integrated device 714 utilizes the clock signal obtained through decoding the satellite radio-frequency signal by the satellite signal processing module 100 to perform the clock calibration on the microwave service signal, the clock signal extracted by the BBU 722 from the microwave service signal after clock calibration is equivalent to the clock signal obtained through decoding the satellite radio-frequency signal by the satellite signal processing module 100), and utilize the clock signal to perform clock calibration and control.

Referring to FIG. 7-b, in an application scenario, the microwave outdoor integrated device 714 may include a microwave intermediate frequency module 7141, a microwave BBU 7142, a service interface module 7143, a clock module 7144, and a microwave RRU 7145.

For example, the satellite radio-frequency signal carries a clock signal, and a signal flow in the base station 700 and a work mode of each module may be:

The satellite antenna 711 receives a satellite radio-frequency signal, and outputs the satellite radio-frequency signal to the satellite signal processing module 100 through a feeder. The satellite signal processing module 100 decodes the satellite radio-frequency signal to obtain a clock signal, and provides the clock signal for the clock module 7144. The clock module 7144 utilizes the clock signal to calibrate the clock, and performs clock control on the other modules of the microwave outdoor integrated device 714. The microwave transmission antenna 713 receives a microwave radio-frequency signal and outputs the microwave radio-frequency signal to the microwave outdoor integrated device 714 through a feeder, the microwave RRU 7145 of the microwave outdoor integrated device 714 performs frequency conversion processing on the microwave radio-frequency signal to obtain a microwave intermediate frequency signal, and the microwave RRU 7145 outputs the microwave intermediate frequency signal to the microwave intermediate frequency module 7141. The microwave intermediate frequency module 7141 further converts the received microwave intermediate frequency signal into a microwave baseband signal, and outputs the microwave baseband signal to the microwave BBU 7142. Under the clock control of the clock module 7144, the microwave BBU 7142 performs baseband service processing on the microwave baseband signal to obtain a corresponding microwave service signal. The service interface module 7143 performs corresponding format conversion on the microwave service signal obtained through processing by the microwave BBU 7142, and outputs the microwave service signal after format conversion to the BBU 722. It can be understood that, because the clock module 7144 utilizes the clock signal obtained through decoding the satellite radio-frequency signal by the satellite signal processing module 100 to calibrate the clock, and the microwave intermediate frequency module 7141, the microwave BBU 7142, and the service interface module 7143 all process the microwave signal under the clock control of the clock module 7144, the clock of the microwave service signal received by the BBU 722 is synchronized with that of the satellite. The BBU 722 may extract the clock signal (equivalent to the clock signal obtained through decoding the satellite radio-frequency signal by the satellite signal processing module 100) from the microwave service signal from the microwave outdoor integrated device 714, and utilize the clock signal to perform clock calibration and control.

It can be seen from the foregoing that, in this embodiment, the satellite signal processing module is set in the microwave outdoor integrated device of the base station outdoor apparatus, and the signal received by the satellite antenna and the signal received by at least one of other antennas after processing are transferred from the base station outdoor apparatus to the base station indoor apparatus through one data line, so that feeder wiring between the base station outdoor apparatus and the base station indoor apparatus is simplified, and meanwhile, the number of the lightning protection modules may also be reduced, and a manufacturing cost is lowered.

In the foregoing embodiments, descriptions of the embodiments have different emphases, and for parts that are not described in detail in one embodiment, reference may be made to the relevant description of another embodiment.

The wireless base station provided in the embodiment of the present disclosure is described in detail above. The principle and implementation of the present disclosure are described here through specific examples. The description about the foregoing embodiments is merely provided for ease of understanding of the method and core ideas of the present disclosure. Persons of ordinary skill in the art may make variations and modifications to the present disclosure in terms of the specific implementations and application scopes according to the ideas of the present disclosure. In conclusion, the specification shall not be construed as limitations to the present disclosure.

What is claimed is:

1. A wireless base station, comprising:
a base station indoor apparatus and a base station outdoor apparatus,
wherein the base station outdoor apparatus comprises an adapter, a terrestrial service antenna, and a satellite antenna; and the terrestrial service antenna comprises a microwave transmission antenna or a wireless access antenna;
the base station indoor apparatus comprises a satellite signal processing module, configured to obtain a satellite service signal by performing decoding processing on a satellite radio-frequency signal received by the satellite antenna; and
the satellite antenna and the terrestrial service antenna are connected to the adapter, and the adapter is configured to couple a signal received by the satellite antenna and a signal received by the terrestrial service antenna, and transfer a coupled signal to the base station indoor apparatus through a first data line.

2. The wireless base station according to claim 1, wherein
if the terrestrial service antenna is a wireless access antenna, the satellite signal processing module is set in a Radio-frequency Unit (RRU) of the base station indoor apparatus.

3. The wireless base station according to claim 1, wherein
if the terrestrial service antenna is a microwave transmission antenna, the satellite signal processing module is set in a Microwave Indoor Unit (IDU) of the base station indoor apparatus.

4. The wireless base station according to any one of claim 1, wherein the satellite radio-frequency signal received by the satellite antenna is from one or more of the following satellites: the Galileo satellite, the Global Positioning System (GPS) satellite, the BeiDou satellite, and the Global Navigation Satellite System (GLONASS) satellite; and
the satellite service signal obtained through decoding processing by the satellite signal processing module comprises a clock signal and/or a position signal.

5. The wireless base station according to claim 1, wherein
after receiving the coupled signal through the first data line, the base station indoor apparatus decouples the coupled signal, and processes a satellite radio-frequency signal and a terrestrial service antenna signal that are obtained by decoupling through a corresponding processing circuit.

6. The wireless base station according to claim 1, wherein
the terrestrial service antenna and the satellite antenna are connected to a lightning protection circuit through the first data line.

7. A wireless base station, comprising:
a base station indoor apparatus and a base station outdoor apparatus,
wherein the base station outdoor apparatus comprises a terrestrial service antenna, a satellite antenna, a satellite signal processing module configured to obtain a satellite service signal by performing decoding processing on a satellite radio-frequency signal received by the satellite antenna, and a first terrestrial service processing module configured to demodulate a modulated signal received by the terrestrial service antenna; and the terrestrial service antenna is a microwave transmission antenna or a wireless access antenna; and
the satellite service signal is transferred to the base station indoor apparatus through a second data line, and the modulated signal, which is received by the terrestrial service antenna and demodulated by the first terrestrial service processing module, is transferred to the base station indoor apparatus through the second data line.

8. The wireless base station according to claim 7, wherein
if the terrestrial service antenna is a wireless access antenna, the first terrestrial service processing module is a Radio-frequency Unit (RRU), and the satellite signal processing module is set in the RRU.

9. The wireless base station according to claim 7, wherein
if the terrestrial service antenna is a microwave transmission antenna, the first terrestrial service processing module is a microwave outdoor integrated device, and the satellite signal processing module is set in the microwave outdoor integrated device.

10. The wireless base station according to claim 8, wherein
the satellite antenna is connected to a lightning protection circuit of the first terrestrial service processing module.

11. A method for receiving a signal of a wireless base station, comprising:
coupling, by an adapter located in a base station outdoor apparatus, a signal received by a satellite antenna and a signal received by a terrestrial service antenna, wherein the terrestrial service antenna comprises a microwave transmission antenna or a wireless access antenna, wherein the microwave transmission antenna or the wire less access antenna is located in the base station outdoor apparatus;
transferring, by the adapter, a coupled signal to a base station indoor apparatus through a first data line; and
obtaining, by a satellite signal processing module located in the base station indoor apparatus, a satellite service signal by performing decoding processing on a satellite radio-frequency signal received by a satellite antenna.

12. The method according to claim 11, further comprising:
decoupling, by the base station indoor apparatus, the coupled signal after receiving the coupled signal through the first data line, and processing the satellite radio-frequency signal and the terrestrial service antenna signal that are obtained by decoupling through a circuit that processes the satellite radio-frequency signal and the terrestrial service antenna signal.

13. A method for receiving a signal of a wireless base station, comprising:
obtaining, by a satellite signal processing module located in a base station outdoor apparatus, a satellite service signal by decoding a satellite radio-frequency signal received by a satellite antenna located in the base station outdoor apparatus;
transferring the satellite service signal to a base station indoor apparatus through a second data line; and
performing, by a first terrestrial service processing module located in the base station outdoor apparatus, demodulation processing on a modulated signal received by a terrestrial service antenna located in the base station outdoor apparatus, and transferring the signal after demodulation processing to the base station indoor apparatus through the second data line.
